(19) United States
(12) Patent Application Publication
(10) Pub. No.: US 2018/0187815 A1
(43) Pub. Date: Jul. 5, 2018

(54) CONNECTION PIPE, TITANIUM SPONGE PRODUCING APPARATUS COMPRISING THE CONNECTION PIPE, TITANIUM SPONGE PRODUCING METHOD USING THE APPARATUS, AND TITANIUM SPONGE PRODUCED BY THE METHOD

(71) Applicant: TOHO TITANIUM CO., LTD., Kanagawa (JP)

(72) Inventor: Minoru YOSHIDA, Kanagawa (JP)

(73) Assignee: TOHO TITANIUM CO., LTD., Kanagawa (JP)

(21) Appl. No.: 15/740,320

(22) PCT Filed: Feb. 16, 2016
(86) PCT No.: PCT/JP2016/054391

§ 371 Date: Dec. 27, 2017

(30) Foreign Application Priority Data
Jun. 30, 2015 (JP) 2015-131635

(51) Int. Cl. F16L 53/38; C22B 34/12; C22B 5/04

(52) U.S. Cl. CPC F16L 53/38; C22B 34/1272; B01J 2219/0013; B01J 2219/00452; C22B 5/04

(57) ABSTRACT

A connection pipe for coupling at least one reaction vessel used in producing titanium sponge with at least one recovering vessel for condensing and recovering magnesium and magnesium chloride separated from the titanium sponge in the reaction vessel; wherein the connection pipe is configured as a dual wall structure constituted of an inner pipe and an outer pipe, and comprises at least one heating unit provided between the inner pipe and the outer pipe, two or more sets of lead terminals located through the outer pipe to provide electrical connection to a power terminal in the outside of the connection pipe, insulators for sealing the lead terminals, lead wires for electrically coupling the heating unit with the lead terminals, and a stress absorbed portion provided on the outer pipe; wherein the stress absorbed portion is provided between the lead terminals thereby preventing short circuit and meltdown of the lead wires.

### TECHNICAL FIELD

The present invention relates to a specific connection pipe of coupling a reaction vessel for producing titanium sponge with a recovering vessel for condensing and recovering magnesium and magnesium chloride separated from the titanium sponge produced in the reaction vessel, and in particular to the connection pipe, which is effectively preventing a short circuit between lead wires connected to a heater unit for raising a temperature of the connection pipe and an outer pipe of the connection pipe caused by thermal expansion and thermal contraction of connection pipe, and also preventing a meltdown of the lead wires.

Further, the present invention relates to an apparatus for producing titanium sponge including the connection pipe , a method for titanium sponge production using the apparatus, and titanium sponge produced by the method.

### BACKGROUND ART

In recent, titanium sponge is flourishingly used as a raw material for titanium metal. Kroll process is industrially and widely employed as a titanium sponge production method. The Kroll process have been improved hitherto and thus production costs of titanium sponge have been greatly reduced. However, further problems are still remained for further improvements.

Examples of such problems may include an extended life of a connection pipe used in a process of separating magnesium and magnesium chloride separated from titanium sponge produced by reducing titanium tetrachloride with magnesium (hereinafter, also referred to as a ‘separation and purification process’). Herein, the connection pipe refers to a pipe for directly or indirectly coupling a reaction vessel used in producing titanium sponge with a recovering vessel for condensing and recovering magnesium and magnesium chloride separated from the titanium sponge produced in the reaction vessel.

FIG. 5 is a schematic view of a conventional titanium sponge producing apparatus 61 used in a separation and purification process of titanium sponge, illustrating a state thereof after the separation and purification process. Herein, the titanium sponge production apparatus 61 includes a reaction vessel 63, a recovering vessel 64 and a connection pipe 62 for coupling therebetween.

In the reaction vessel 63 prior to the separation and purification process, titanium sponge produced by reducing a titanium tetrachloride with magnesium is held with both by-produced magnesium chloride and unreacted magnesium in the reduction reaction. Also, the empty recovering vessel 64 is installed prior to the separation and purification process. A water-cooling system, not shown, is equipped on the outside of the recovering vessel 64.

In the separation and purification process, the titanium sponge producing apparatus 61 is maintained in a reduced pressure, the inside temperature of reaction vessel 63 is heated up to around 900° C. or 1000° C. by a heater unit, not shown, and the recovering vessel 64 is maintained at a temperature lower than melting points of magnesium and magnesium chloride by the water-cooling system equipped thereon.

In the separation and purification process, the magnesium chloride and magnesium contained in titanium sponge in the reaction vessel 63 is evaporated and then the magnesium chloride and magnesium vapor is moved into the recovering vessel 64 via the connection pipe 62 coupled with the reaction vessel 63. Because the outside of the recovering vessel 64 is in a cooled state, the magnesium chloride and magnesium vapor reached an inner wall surface of the recovering vessel and then those vapors are condensed, which are recovered as a solid magnesium chloride and magnesium 66.

Due to this mechanism, the magnesium chloride and magnesium contained in the titanium sponge held in the reaction vessel 63 are separated from the titanium sponge and removed and thus a high-purity titanium sponge 65 can be obtained.

In the separation and purification process of magnesium chloride, the connection pipe 62 are coupled to the reaction vessel 63, which is maintained at a higher temperature, and the recovering vessel 64, which is maintained at around the room temperature.

Accordingly, the connection pipe 62 is exposed to a temperature history from the room temperature upto around 1000° C. and thus a stress and strain is induced by thermal expansion and thermal contraction. As a result, a problem arises in that the connection pipe 62 is deformed and the coupling procedure is not completed between the reaction vessel 63 and the recovering vessel 64.

In order to solve the problem, an improved connection pipe 81 has been proposed, in which a stress absorbed portion 88 is located as shown in FIG. 6. In this case, the connection pipe 81 is configured as a dual wall structure by an inner pipe 82 and an outer pipe 83, and heating units 84 are installed in a space between the inner pipe and the outer pipe. Also, the heating units 84 and the lead terminals 85 are electrically connected to each other by lead wires (heater leads) 87, the lead terminals 85 are sealed with insulators 86, and the lead terminals 85 is wired through the outer pipe 83 to provide an electrical connection to power terminal in the outside of the connection pipe 81. In addition, the stress absorbed portion 88 is installed on the outer pipe 83. Also, magnesium and magnesium chloride pass through a space surrounded by the inner pipe 82 (hereinafter, also referred to as ‘an inside of the inner pipe’).

By using this connection pipe, a stress caused by thermal expansion and thermal contraction can be absorbed by the stress absorbed portion 88 and thus deformation of the connection pipe 81 can be reduced (PTL 1).

However, when the connection pipe 81 is used, even though the connection pipe 81 is expanded or contracted in accordance with expansion or contraction of the inner pipe 82 during heating or cooling, an amount of the heating units 84 movement is not necessarily identical to an amount of expansion or contraction of the connection pipe 81. Accordingly, the lead terminals 85 is subjected to a stress and thus the insulators 86 are damaged ,which is provided on joint portions between the lead terminals 85 and the outer pipe 83. As a result, it has been found a short circuit between the lead wires 87 and the outer pipe 83 or meltdown of the lead wires 87. Therefore, even if the connection pipe 81 is used, the separation and purification process is likely to be interrupted while the separation and purification process is performed through several times.

### CITATION LIST

### Patent Literature

PTL 1: Japanese Unexamined Patent Application Publication No. 2001-280576

### SUMMARY OF INVENTION

### Technical Problem

The present invention has been made keeping in mind the above problems and an object to be solved by the present invention is to provide to a connection pipe used in a production and purification process of titanium sponge by Kroll process, in which short circuit between lead wires and an outer pipe and meltdown of the lead wires are not occurred and thus a life thereof is extended. Further, other objects to be solved by the present invention is to provide a titanium sponge producing apparatus including the connection pipe, a titanium sponge producing method using the apparatus, and titanium sponge produced by the method.

### Solution to Problem

The inventors have performed intensive studies in order to solve the above objects, and as a result have found that if a stress absorbed portion and lead wires of a connection pipe are appropriately located each other, short circuit between lead wires and an outer pipe and meltdown of the lead wires are not occurred and thus a life thereof can be extended.

The present invention has been made based on such findings and is as follows:

[1] A connection pipe for coupling at least one reaction vessel used in producing titanium sponge with at least one recovering vessel for condensing and recovering magnesium and magnesium chloride separated in the reaction vessel;

wherein the connection pipe is configured as a dual wall structure constituted of an inner pipe and an outer pipe, and comprises at least one heating unit provided between the inner pipe and the outer pipe, two or more sets of lead terminals penetrating through the outer pipe to provide an electrical connection to power terminal in the outside of the connection pipe, insulators for sealing the lead terminals, lead wires for electrically coupling the heating unit with the lead terminals, and a stress absorbed portion provided on the outer pipe;

wherein the stress absorbed portion is provided between the lead terminals.

[2] The connection pipe according to the above [1], wherein two or more heating units are provided between the inner pipe and the outer pipe.

[3] The connection pipe according to any one of the above [1] and [2], wherein a bellows is used as the stress absorbed portion.

[4] The connection pipe according to any one of the above [1] to [3], wherein the connection pipe is intended to connect one reaction vessel with one recovering vessel.

[5] The connection pipe according to the above [4], wherein the stress absorbed portion is positioned at the middle in a longitudinal direction of the connection pipe.

[6] A titanium sponge producing apparatus comprising the connection pipe according to any one of the above [1] to [5], a reaction vessel, and a recovering vessel.

[7] A titanium sponge producing method comprising using the apparatus according to the above [6].

[8] A titanium sponge produced by the method according to the above [7].

### Advantageous Effects of Invention

The present invention can provided a connection pipe in which short circuit between lead wires and an outer pipe and meltdown of the lead wires are not occurred and thus a life thereof is extended. Accordingly, the special effect that a separation and purification process of titanium sponge can be proceeded without being interrupted through a plurality of batches and thus an efficiency of the titanium sponge producing method can be enhanced can be achieved.

### BRIEF DESCRIPTION OF DRAWINGS

FIG. 1 is a schematic view explaining a connection pipe according to an embodiment of the present invention.

FIG. 2 is a schematic view explaining an A-A cross-section of the connection pipe shown in FIG. 1.

FIG. 3 is a schematic view explaining a connection pipe according to another embodiment of the present invention.

FIG. 4 is a schematic view explaining a connection pipe according to a further embodiment of the present invention.

FIG. 5 is a schematic view explaining a titanium sponge producing apparatus of an embodiment of the present invention.

FIG. 6 is a schematic view explaining a conventional connection pipe.

### DESCRIPTION OF EMBODIMENTS

A connection pipe of the present invention is configured as a dual wall structure constituted of an inner pipe and an outer pipe and includes at least one heating unit, two or more sets of lead terminals sealed with insulators, lead wires and a stress absorbed portion, and the stress absorbed portion is provided between the lead terminals.

The connection pipe is used to connect at least one reaction vessel, which is used in producing titanium sponge, with at least one recovering vessel, which is intended to condense and recover magnesium and magnesium chloride separated from the titanium sponge produced in the reaction vessel.

The stress absorbed portion of the present invention is provided between the lead terminals.

The lead terminals are typically installed so that one set of two positive and negative terminals is located in a vertical cross section of the connection pipe. Although the connection pipe of the present invention can be installed with two or more sets of lead terminals, only two sets are preferably installed to prevent wiring of the lead wires from being complicated.

As used herein, the phrase ‘vertical cross section of the connection pipe’ means a cross section when the connection pipe is cut perpendicular to a direction along which magnesium and magnesium chloride flow inside the inner pipe.

Also, the phrase ‘stress absorbed portion is provided between the lead terminals’ means that the stress absorbed portion is provided so that a vertical cross section of the connection pipe containing the stress absorbed portion is located between and also not overlapped with two vertical cross-sections of the connection pipe containing lead terminals constituted by each of two sets of lead terminals. If two or more stress absorbed portions exist, it means that all stress absorbed portions are provided at locations satisfying the relationship described above. If three or more sets of lead terminals exist, it means that at least two sets of lead terminals in a plurality of sets of lead terminals satisfy the above relationship to the stress absorbed portion.

As described above, the lead terminals are typically installed in such a manner that one set of two positive and negative terminals is located in one vertical cross section of the connection pipe, and also this installation manner is preferable. If two positive and negative terminals constituting one set of lead terminals do not exist together in one vertical cross section of the connection pipe, one vertical cross section which is closer to a vertical cross section of the connection pipe containing the stress absorbed portion among a vertical cross section of the connection pipe containing the positive terminal and a vertical cross section of the connection pipe containing the negative terminal is regarded as the vertical cross section of the connection pipe containing the lead terminals, and on the basis of this, the positional relationship between the stress absorbed portion and the lead terminals of the present invention is decided.

By providing the stress absorbed portion in this way, no force is exerted to the lead wires even if the stress absorbed portion is deformed due to the strain absorption caused by the thermal expansion or thermal contraction of the connection pipe. Accordingly, no risk will arise that the lead wires are disconnected, and also that a force exerted on the lead wires causes the lead terminals and the insulators for sealing the lead terminals to be moved so that the lead wires and the outer pipe are short-circuited therebetween.

Namely, during raising or lowering of temperature of the connection pipe, the stress absorbed portion acts in the present invention as follows.

When the inner pipe is expanded during raising of temperature of the connection pipe, the outer pipe can expand to correspond to the inner pipe without substantially exerting any force on the lead terminals due to the presence of the stress absorbed portion equipped as in the present invention.

Similarly, when the inner pipe is contracted during lowering of temperature of the connection pipe, the outer pipe can expand to correspond to the inner pipe without substantially exerting any force on the lead terminals due to the presence of the stress absorbed portion equipped as in the present invention.

The stress absorbed portion is not particularly limited so long as a stress caused by thermal expansion or thermal contraction of the connection pipe can be absorbed, but for example, may include a stress absorbed portion employing a bellows. As installation aspects of the bellows, for example, an aspect in which a part of the outer pipe is constructed by a bellows, or an aspect in which an outer pipe separation section is provided by cutting the outer pipe along a circumference thereof in a vertical cross section of the connection pipe and a bellows is provided to be covered on an outside of the outer pipe separation section can be included.

A material, of which the stress absorbed portion is constructed, is not particularly limited, but for example may include stainless steel. If the stress absorbed portion is constructed of stainless steel, this is preferable in that even when the stress absorbed portion is maintained at an increased temperature, the deformation or damage will not occur thereto and thus an interior atmosphere thereof can effectively blocked from the atmospheric air.

In the connection pipe, only one stress absorbed portion may be installed or two or more stress absorbed portions may be installed. When two or more stress absorbed portions are installed, a strain caused by thermal expansion or thermal contraction of the connection pipe can be more effectively absorbed.

However, because manufacturing costs of the connection pipe is increased in proportion to the number of stress absorbed portions, the number of stress absorbed portions is preferably practically one or two.

Also, in terms of construction, the stress absorbed portion is preferably configured so that the stress absorbed portion and the heating unit do not exist together in one vertical cross section of the connection pipe.

The inner and outer pipes according to the present invention are tubular members opened at both ends thereof and constitute the dual wall structure of the connection pipe. In the connection pipe of the present invention, magnesium and magnesium chloride flow through the inside of the inner pipe.

Materials, of which the inner and outer pipes are constructed, are not particularly limited, but for example, may include stainless steel. A shape of each of the inner and outer pipes is preferably of a cylindrical shape.

The heating unit of the present invention is installed between the inner pipe and the outer pipe. The heating unit is electrically connected to the lead terminals via the lead wires, and also is electrically connected to power terminal in the outside of the connection pipe via the lead terminals.

The heating unit is not particularly limited so long as the heating unit can maintain the inside of the inner pipe at about 700° C. to 900° C., but for example, may include an electric heater.

Preferably, two or more heating units are installed in the connection pipe, and more preferably two heating units are installed. Also, when two or more heating units are installed, the heating units are preferably installed at a distance from each other. A length of a space portion defined by such a distance is preferably set to a range of 5% to 10% of the entire length of the connection pipe.

If the length of the space portion is set to such a range, the effect of inhibiting fracture of the heating unit of the connection pipe can be enhanced, and also an amount of heat emitted from the space portion can be limited to be equal to or less than a predetermined amount. As a result, an excessive reduction in temperature of the inside of the connection pipe can be also inhibited.

Further, by providing the space portion, a compressive stress in accordance with thermal expansion of the heating unit can be effectively relieved. As a result, fracture of the heating unit caused by the compressive stress can be prevented.

Meanwhile, the space portion and the stress absorbed portion do not need to exist together in one vertical cross section of the connection pipe and thus can be appropriately determined in consideration of positional relationships to other members installed inside and/or outside the connection pipe.

A positional relationship between the heating unit and the stress absorbed portion is not particularly limited, but in terms of construction, for example, when two heating units are installed, the heating units are preferably located on both sides of a vertical cross section of the connection pipe containing the stress absorbed portion.

The connection pipe of the present invention may be configured to be coupled to the reaction vessel and the recovering vessel via flanges installed on end portions thereof. In order to relieve strains on the flanges, the flanges may be provided with flange stress absorbed portions different from the stress absorbed portion of the present invention. By installing the flange stress absorbed portions, strains of the flanges caused by thermal expansion or thermal contraction of the connection pipe can be relieved, thereby allowing the connection pipe to be smoothly engaged with the reaction vessel and the recovering vessel.

The connection pipe of the present invention is preferably coupled with the one reaction vessel and one recovering vessel. In this case, the stress absorbed portion is preferably positioned at the middle portion in a longitudinal direction of the connection pipe.

Meanwhile, the phrase ‘longitudinal direction of the connection pipe’, as used herein, means a direction along which, in the connection pipe coupling one reaction vessel and one recovering vessel, magnesium chloride and magnesium vapors flow through the inside of the connection pipe.

The connection pipe of the present invention may include any other members not described above. For example, an insulation material may be provided between the inner pipe and the outer pipe, and also rubber gaskets may be provided on the flanges.

The present invention relates to a titanium sponge producing apparatus, which includes the connection pipe as described above, a reaction vessel and a recovering vessel, and also to a titanium sponge producing method using the producing apparatus. Because the connection pipe included in the titanium sponge producing apparatus has an extended life and also there is no risk that a separation and purification process of titanium sponge is interrupted, the efficiency of the separation and purification process of titanium sponge is improved and thus titanium sponge can be efficiently produced.

In the titanium sponge producing method, the reaction vessel prior of the separation and purification process holds therein titanium sponge produced by a magnesium reduction reaction of titanium tetrachloride and containing by-produced magnesium chloride and unreacted magnesium. Also, the recovering vessel prior to the separation and purification process holds nothing therein and is provided in an empty state. The recovering vessel is connected to the reaction vessel via the connection pipe.

In the separation and purification process, the insides of the reaction vessel, the recovering vessel and the connection pipe become in a reduced pressure state or vacuum state as necessary. The reaction vessel is heated up to around 900° C. to 1000° C. by a heater unit, not shown, so that the magnesium chloride and magnesium contained in the titanium sponge in the reaction vessel are evaporated and then moved into the recovering vessel via the connection pipe.

Vapors of magnesium chloride and magnesium moved into the recovering vessel are condensed and solidified on a inside wall surface of the recovering vessel and thus are respectively recovered as a solid magnesium chloride and a solid magnesium. As a result, amount of the magnesium chloride and magnesium remained in the titanium sponge inside the reaction vessel are decreased and thus a high-purity titanium sponge can be obtained.

Further, the present invention relates to titanium sponge produced by the titanium sponge producing method as described above.

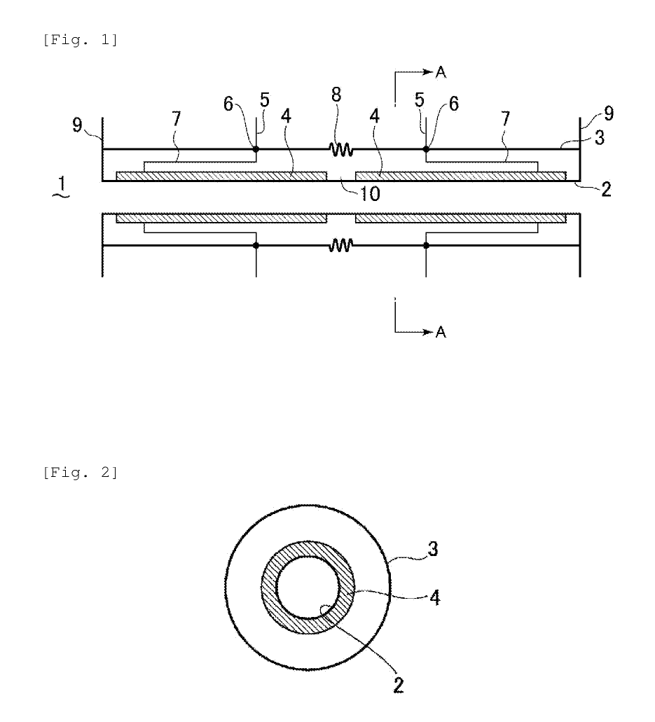

Next, an embodiment of the connection pipe of the present invention will be described in detail on the basis of FIG. 1.

FIG. 1 is a schematic sectional view showing a connection pipe 1 including a cylindrical inner pipe 2, a cylindrical outer pipe 3, heating units 4, lead terminals 5, insulators 6, lead wires 7, a stress absorbed portion 8 and flanges 9, as taken along a longitudinal direction of the connection pipe. The connection pipe 1 has two heating units 4 provided between the inner pipe 2 and the outer pipe 3, and the heating units are provided with a space portion 10 interposed therebetween.

Meanwhile, in the present embodiment, the stress absorbed portion 8 is positioned at the middle in the longitudinal direction of the connection pipe 1.

FIG. 2 is a schematic view of an A-A cross section of the connection pipe shown in FIG. 1 (vertical cross section of the connection pipe). The heating units 4 are installed in a space portion delimited by the outer pipe 3 and the inner pipe 2 to be in contact with the inner pipe 2. At this time, the heating units 4 are preferably installed in such an extent that the heating units 4 are slidable along a surface of the inner pipe 2.

By employing the slidable structure as described above, a stress created in accordance with thermal contraction of the connection pipe can be effectively alleviated.

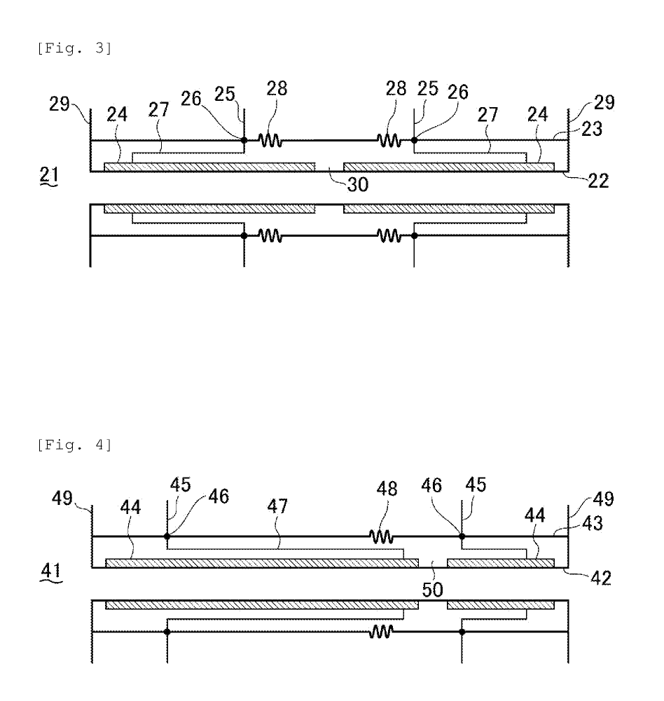

FIG. 3 is a schematic view explaining another embodiment of a connection pipe according to the present invention.

A connection pipe 21 of the present embodiment includes a cylindrical inner pipe 22 and a cylindrical outer pipe 23 and has stress absorbed portions 28 installed at two locations thereon. In the present embodiment, also, the stress absorbed portions 28 are installed between two sets of lead terminals 25.

FIG. 4 is a schematic view explaining a further embodiment of a connection pipe according to the present invention.

A connection pipe 41 of the present embodiment includes a cylindrical inner pipe 42 and a cylindrical outer pipe 43 and has a stress absorbed portion 48 installed at other location than the middle in the longitudinal direction of the connection pipe. In the present embodiment, also, the stress absorbed portion 48 is installed between two sets of lead terminals 45.

### EXAMPLES

Separation and purification of the titanium sponge is performed under the following conditions.

### 1. Equipment Conditions

1) Reaction vessel
A. Shape: a cylindrical vessel with a lid
B. Material: stainless steel

2) Recovering vessel

Using the same as the reaction vessel.
A. Shape: a cylindrical vessel with a lid
B. Material: stainless steel

3) Connection pipe
A. Shape: a dual pipe having flanges at both ends thereof
B. Material: stainless steel

4) Heating unit
A. Shape: two-split cylindrical heating plate
B. Heating body: kanthal wire
C. The number of lead terminals: 4 (2 per each heating unit)

### 2. Test Method

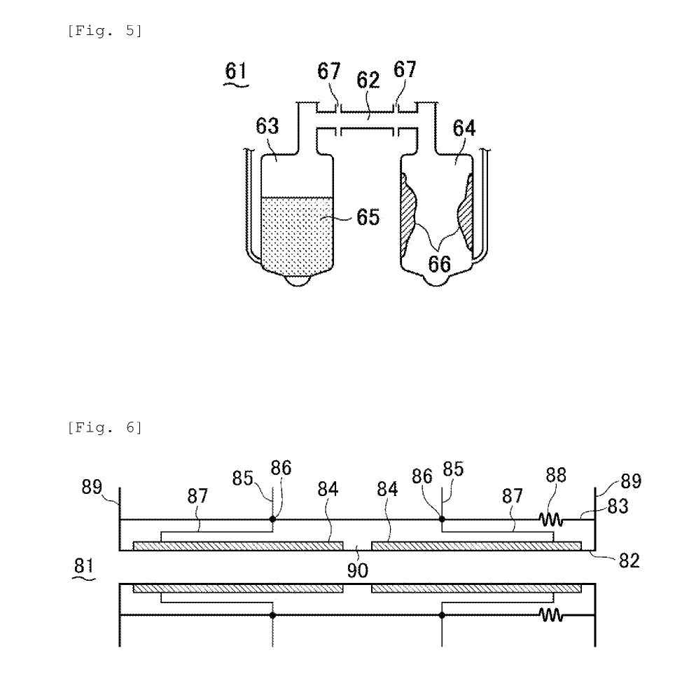

Separation and purification of titanium sponge was performed using a titanium sponge producing apparatus 61 shown in FIG. 5. The titanium sponge producing apparatus 61 included a connection pipe 62, a reaction vessel 63 and a recovering vessel 64, and flanges 67 were respectively provided on connection portions of the connection pipe 62 to the reaction vessel 63 and the recovering vessel 64.

Titanium sponge produced by a magnesium reduction reaction of titanium tetrachloride and containing by-produced magnesium chloride and unreacted magnesium in the magnesium reduction reaction was held in the reaction vessel 63. The inside of the reaction vessel 63 was heated at 950° C. to 1000° C. by an electric oven (not shown) outside the reaction vessel, the connection pipe 62 was heated at an inner pipe wall temperature of 800° C. to 900° C. by a heating unit, and also surfaces of the recovering vessel 64 was water-cooled so that the inside thereof becomes in a reduced pressure state (about 1.3×10⁻² Pa).

If the separation and purification process is proceeded, the magnesium chloride and magnesium 66 remained in the titanium sponge are condensed and recovered in the recovering vessel 64. Fluctuation of the reduced pressure state described above was monitored, and on the basis of a timing at which the pressure was converged to a predetermined value, the titanium sponge producing apparatus was lowered in temperature. In this way, one batch of the separation and purification process was ended. As a result, a titanium sponge 65 having a high purity was recovered from the reaction vessel 63.

### Example 1

Separation and purification of titanium sponge was performed using the connection pipe 1 shown in FIG. 1 as the connection pipe 62 shown in FIG. 5. A stress absorbed portion 8 was provided at the middle in the longitudinal direction of the connection pipe 1. Lead terminals 5, two (one set) per each heating unit, four in total (two sets in total), were provided.

As shown in FIG. 1, in the connection pipe 1 of Example 1, the stress absorbed portion 8 was provided between two sets of lead terminals engaged with two heating units.

Also, a space portion 10 was provided so that a distance between two heating units 4 corresponds to 7% of a length in the longitudinal direction of the connection pipe 1.

Forty batches of separation and purification processes were repeated under the conditions as described above.

In Example 1, separation and purification of titanium sponge corresponding to forty batches could be performed without interrupting operation during the separation and purification processes. Also, a noticeable damage or deformation was not found in the lead terminals 5.

### Comparative Example 1

Separation process of titanium sponge was performed in the same manner as those in Example 1, except that the connection pipe 81 shown in a schematic view of FIG. 6 was used as the connection pipe 62 shown in FIG. 5. The connection pipe 81 used in Comparative Example 1 used the same structures and members as those of the connection pipe 1 of Example 1, except that a stress absorbed portion 88 was positioned at a different location.

Separation and purification of titanium sponge was repeated using the connection pipe 81 under the same conditions as those of Example 1. When the separation and purification procedure of titanium sponge corresponding to thirty batches was performed, lead terminals 85 of the connection pipe 81 were deformed and a risk of short circuit between lead wires 87 and an outer pipe 83 was detected. Accordingly, it was impossible to conduct the separation and purification procedure after the 31st batch.

From the above results, it has been revealed that the connection pipe of the present invention is effectively improved from the view of short circuit between the lead wires and the outer pipe and meltdown of the lead wires caused by thermal expansion and thermal contraction of the connection pipe. As a result, it has been revealed that as compared with conventional connection pipes, the connection pipe of the present invention has an extended life and also allows separation and purification of titanium sponge to be effectively performed.

### INDUSTRIAL APPLICABILITY

The connection pipe of the present invention can be suitably used for producing titanium sponge by a Kroll process.

### REFERENCE SIGNS LIST

1, 21, 41, 81 Connection pipe

2, 22, 42, 82 Inner pipe

3, 23, 43, 83 Outer pipe

4, 24, 44, 84 Heating unit

5, 25, 45, 85 Lead terminal

6, 26, 46, 86 Insulator

7, 27, 47, 87 Lead wire

8, 28, 48, 88 Stress absorbed portion

9, 29, 49, 89 Flange

10, 30, 50, 90 Space portion

61 Titanium sponge producing apparatus

62 Connection pipe

63 Reaction vessel

64 Recovering vessel

65 Titanium sponge

66 Magnesium chloride and magnesium

67 Flange

1. A connection pipe for coupling at least one reaction vessel used in producing titanium sponge with at least one recovering vessel for condensing and recovering magnesium and magnesium chloride separated from the titanium sponge in the reaction vessel;
wherein the connection pipe is configured as a dual wall structure constituted of an inner pipe and an outer pipe, and comprises at least one heating unit provided between the inner pipe and the outer pipe, two or more sets of lead terminals located through the outer pipe to provide an electrical connection to power terminal in the outside of the connection pipe, insulators for sealing the lead terminals, lead wires for electrically coupling the heater unit with the lead terminals, and a stress absorbed portion provided on the outer pipe;
wherein the stress absorbed portion is provided between the lead terminals.

2. The connection pipe according to claim 1, wherein two or more heating units are provided between the inner pipe and the outer pipe.

3. The connection pipe according to claim 1, wherein a bellows is used as the stress absorbed portion.

4. The connection pipe according to claim 1, wherein the connection pipe is intended to connect one reaction vessel with one recovering vessel.

5. The connection pipe according to claim 4, wherein the stress absorbed portion is located at the middle in a longitudinal direction of the connection pipe.

6. A titanium sponge producing apparatus comprising the connection pipe according to claim 1, a reaction vessel, and a recovering vessel.

7. A titanium sponge producing method comprising using the apparatus according to claim 6.

8. A titanium sponge produced by the method according to claim 7.
